(19) United States
(12) Patent Application Publication
(10) Pub. No.: US 2013/0012912 A1
(43) Pub. Date: Jan. 10, 2013

(54) MULTI-CHAMBERED CONTAINER FOR MEDICAL USE, DRUG MIXTURE IDENTIFICATION METHOD USING THE SAME, AND DRUG-FILLED MULTI-CHAMBERED CONTAINER FOR MEDICAL USE

(75) Inventors: Satoshi Suzuki, Chiyoda-ku (JP); Masamitsu Miyake, Hiroshima-shi (JP); Josuke Baba, Hiroshima-shi (JP)

(73) Assignee: HOSOKAWA YOKO CO., LTD., Chiyoda-ku, Tokyo (JP)

(21) Appl. No.: 13/635,021

(22) PCT Filed: Mar. 16, 2011
(86) PCT No.: PCT/JP2011/056205

§ 371 Date: Sep. 14, 2012

(30) Foreign Application Priority Data
Mar. 18, 2010 (JP) 2010-062678

(51) Int. Cl. A61J 1/20

(52) U.S. Cl. 604/410

(57) ABSTRACT

A multi-chambered container for medical use (10) includes a container main body (20) having flexibility, a weak seal part (26) that is detachable and seals opposing faces of the container main body, drug storing chambers (22, 24) formed in such a way that the container main body is partitioned into two or more by the weak seal part, and a pair of resonance tags (30, 40) that are provided in the container main body so as to interpose the weak seal part.

### TECHNICAL FIELD

The present invention relates to a multi-chambered container for medical use, a drug mixture identification method using the same, and a drug-filled multi-chambered container for medical use. Priority is claimed on Japanese Patent Application No. 2010-062678, filed Mar. 18, 2010, the content of which is incorporated herein by reference.

### BACKGROUND ART

Administration in the form of injection, drip, or the like is performed on patients by mixing a plurality of drugs such as mixing a vitamin preparation, or the like with physiological saline solution. When a plurality of drugs are to be mixed, some kinds of drugs are denatured if they are mixed beforehand. In the past, when drugs that are likely to be denatured are to be combined, a drug contained in a glass container is mixed by injection of another drug using a syringe, or the like right before use. During such mixing, there is a possibility of human error such as having the wrong mixing ratio, forgetting mixing, and the like.

In order to avoid mistakes occurring in mixing drugs as described above, a system has been proposed in which two or more kinds of drugs are combined based on an input prescription (for example, Patent Document 1). However, in a case requiring urgency, or the like, it is necessary to precisely mix drugs in a simple way. Responding to such a request, a multi-chambered container for medical use as follows has been known (for example, Patent Document 2). The multi-chambered container for medical use includes a plurality of medicine storing chambers provided with a low-adherent seal part partitioning the container main body. In such a multi-chambered container for medical use, each drug is stored in the medicine storing chambers without being mixed. Drugs are mixed by peeling open the low-adherent seal part partitioning the medicine storing chambers by exerting external pressure on the medicine storing chambers before being used. Thanks to the use of the multi-chambered container for medical use, it is possible to mix two or more kinds of drugs with the accurate mixing ratio.

When the multi-chambered container for medical use described above is used, it is possible to simplify the work of mixing a plurality of drugs, however, mixing the drugs has to be visually confirmed. In this sense, there is a possibility of forgetting peeling open the low-adherent seal part. In addition to that, a transparent packing material is used for infusion containers for medical purposes in many cases so that the content can be visually checked. For this reason, it is difficult to ascertain that the low-adherent seal part has been peeled open.

With regard to the problem, another multi-chambered container for medical use has been proposed, in which a low-adherent seal part is peeled open by elevation of pressure in the drug storing chambers with part of the container main body being fixed by a fixing member in a bent state, and peeling open the low-adherent seal part can be easily ascertained by undoing the bent state (for example, Patent Document 3). In addition, another multi-chambered container for medical use has been proposed in which a plurality of spaces created in an isolated manner and tear opening parts that are torn and opened by an external force to enable a medical material to move between the spaces are provided, and an RFID (Radio Frequency Identification) arrayed near the tear opening parts gets torn to disable communication when the parts are torn to open the spaces (for example, Patent Document 4). The multi-chambered container for medical use disclosed in Patent Document 4 can sense tearing and opening through disabled communication of the RFID, instead of visually checking tearing and opening.

### PRIOR ART DOCUMENT

### Patent Document

[Patent Document 1] Published Japanese Translation No.2007-515213 of the PCT International Publication

[Patent Document 2] Japanese Patent Application, First Publication No.2003-111818

[Patent Document 3] Japanese Patent Application, First Publication No.2007-282707

[Patent Document 4] Japanese Patent Application, First Publication No.2007-267869

### SUMMARY OF INVENTION

### Problem to be Solved by the Invention

However, in the technique of Patent Document 4, when communication is disabled due to unexpected breakage of the RFID, there is a possibility that the tear opening parts are recognized to be open by tearing even in the state where the parts are not torn and open, and drugs before mixture are erroneously administered. In addition, the RFID has a complicated structure and incurs high cost as a disposable material.

Therefore, the present invention aims to provide a multi-chambered container for medical use that makes the work of mixing drugs easy, and enables assured drug mixing work at a low cost without relying only on visual checking, a drug mixture identification method using the same, and a drug-filled multi-chambered container for medical use.

### Means for Solving the Problem

A multi-chambered container for medical use according to the present invention includes a container main body having flexibility, a weak seal part that is detachable and seals opposing faces of the container main body, drug storing chambers formed in such a way that the container main body is partitioned into two or more by the weak seal part, and a pair of resonance tags that are provided in the container main body so as to interpose the weak seal part.

A drug mixture identification method according to the present invention uses the multi-chambered container for medical use storing two or more kinds of drugs, and includes the steps of setting the weak seal part to be in a state of performing sealing, mixing two or more kinds of drugs by detaching the weak seal part and setting the pair of resonance tags to be apart from each other, and allowing at least one of the pair of resonance tags to resonate by electromagnetic waves from transmission means so as to send echo waves and identifying detachment of the weak seal part after reception means receives the echo waves.

A drug-filled multi-chambered container for medical use according to the present invention is configured so that the multi-chambered container for medical use stores drugs.

### Effects of Invention

According to the present invention, it is possible to provide a multi-chambered container for medical use that enables an easy work of mixing drugs and drug mixture in an assured manner without relying on only visual contact, at a low cost, a drug mixture identification method, and a drug-filled multi-chambered container for medical use using the same. Accordingly, it is possible to reliably and accurately confirm medical practice.

### BRIEF DESCRIPTION OF DRAWINGS

FIG. 1 is a perspective view showing an embodiment of a multi-chambered container for medical use according to the present invention.

FIG. 2 is a cross-sectional view taken along line I-I′ of the multi-chambered container for medical use of FIG. 1.

FIG. 3A is a plan view showing a resonance tag used in the multi-chambered container for medical use of FIG. 1 as viewed from one side thereof.

FIG. 3B is a side view showing the resonance tag used in the multi-chambered container for medical use of FIG. 1 as viewed in the longitudinal direction.

FIG. 4 is a plan view showing another example of the resonance tag as viewed from one side thereof.

FIG. 5 is a cross-sectional view showing a state in which a weak seal part of the multi-chambered container for medical use of FIG. 1 is removed.

### DESCRIPTION OF EMBODIMENTS

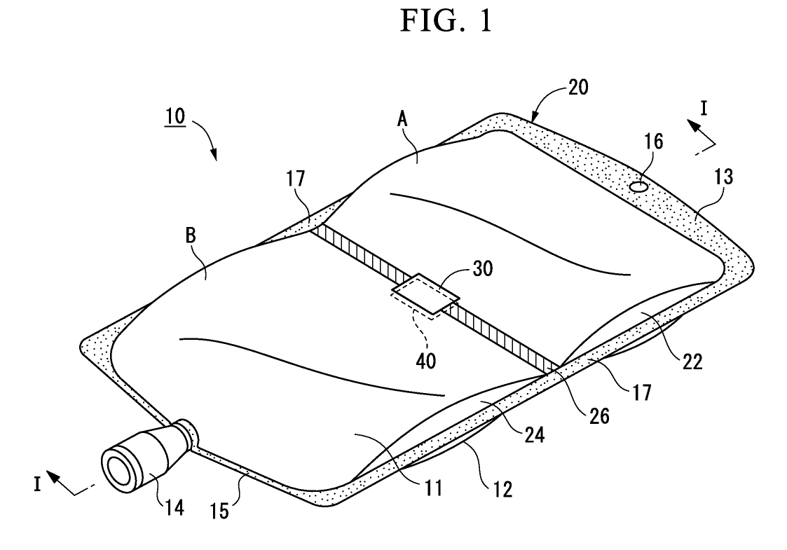

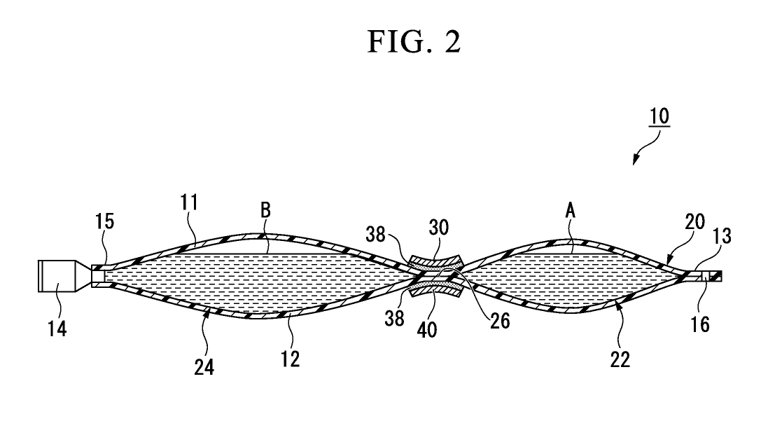

An embodiment of a multi-chambered container for medical use according to the present invention will be described using FIGS. 1 and 2. FIG. 1 is a perspective view showing an example of a multi-chambered container for medical use 10 of the present invention. FIG. 2 is a cross-sectional view taken along line I-I′ of FIG. 1.

The multi-chambered container for medical use 10 according to the embodiment has a flexible container main body 20 in a rectangular shape. The container main body 20 is formed such that the circumference parts of two flexible films 11 and 12 are fused so as not to be separable, and has a weak seal part 26 that seals opposing faces other than the circumference parts of the flexible films 11 and 12 so as to be separable. The weak seal part 26 is provided in a straight line shape in the short side direction of the container main body 20, and accordingly, the container main body 20 is partitioned into a first drug storing chamber 22 and a second drug storing chamber 24. In addition, the first drug storing chamber 22 and the second drug storing chamber 24 are arranged side by side in the longitudinal direction of the container main body 20.

In a lower end part 15 of the container main body 20, an outlet 14 that is made of a resin and formed in a hollow shape being interposed by the flexible films 11 and 12 is provided. The outlet 14 is plugged by a rubber plug (not shown in the drawing) during transportation or storage, and a plug-piercing needle can be inserted into the outlet during the use. In addition, in the outlet 14, a protective film (not shown in the drawing) that covers the face into which the plug-piercing needle can be inserted is detachably provided. Furthermore, the outlet 14 communicates with a second drug storing chamber 24, and a rubber plug (not shown in the drawing), or the like blocks outflow of a drug. In addition, a circular hanging hole 16 is provided in the circumference part of an upper end part 13.

Resonance tags 30 and 40 adhere respectively by an adhesive 38 to one face of the weak seal part 26 (the outer face of the flexible film 11) and the other face of the weak seal part 26 (the outer face of the other flexible film 12). Two resonance tags 30 and 40 making a pair face each other and are arranged so as to interpose the weak seal part 26.

The resonance tags 30 and 40 resonate by electromagnetic waves of a specific frequency sent from transmission means such as a communication device, or the like, and send echo waves. The specific frequency is called a resonant frequency. The resonance tag is also called a resonance label, an RF tag, an RF label, or the like, and also called a shoplifting-prevention tag in practical use. Such a resonance tag is used in order to prevent shoplifting in such a way that, when a resonance tag is attached to a product in a retail shop and the product is unfairly taken out for example, an echo wave sent by the resonance tag is received by reception means so that an alarm sounds, or the like.

The pair of the resonance tags 30 and 40 are positioned adjacent to each other when the weak seal part 26 is sealed and not detached, and so that, they mutually prevent communication of the other. For this reason, even when the electromagnetic wave of the specific frequency described above is sent from the transmission means, neither of the resonance 30 nor 40 resonate.

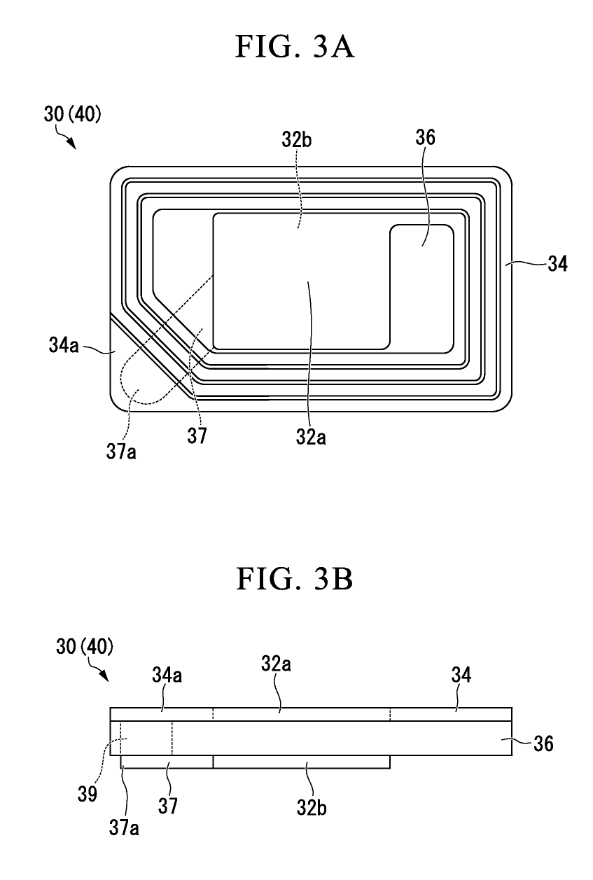

FIGS. 3A and 3B are diagrams showing the resonance tags 30 and 40 that are used in this embodiment. FIG. 3A is a plan view showing the resonance tags 30 and 40 as viewed from one side thereof, and FIG. 3B is a side view of the resonance tags 30 and 40.

The resonance tags 30 and 40 of the embodiment are formed in a sheet shape such as a tag shape, a label shape, or the like, and in which on one face of a film-like base material 36, a planar electrode 32a and a spiral antenna part 34 that continues from the electrode 32a are formed, and on the other face of the film-like base material 36, an electrode 32b making a pair with the electrode 32a and a lead wire part 37 that continues from the electrode 32b are formed. The edge portion 37a of the lead wire part 37 and the edge portion 34a of the antenna part 34 are connected to each other by a connection part 39 penetrating the base material 36, which forms an LC resonance circuit as a whole. In addition, in the embodiment, the electrodes 32a and 32b making a pair are arranged substantially at the center of the base material 36, and the spiral antenna part 34 is arranged so as to surround the electrodes. Furthermore, the other face of the resonance tags 30 and 40 (the face on which the lead wire part 37 is formed) adheres to the flexible films 11 and 12 by the adhesive 38.

The flexible films 11 and 12 to which the resonance tags 30 and 40 adhere is a resin used in the field of a medical container, and the resin is a material that does not hinder communication of the resonance tags 30 and 40. In the multi-chambered container for medical use 10, when the weak seal part 26 is detached, which will be described in more detail later, at least one of the resonance tags 30 and 40 resonates at a specific frequency from the transmission means and emits echo waves. Then, as the echo waves are received by the reception means, the detachment of the weak seal part 26 is recognized. For this reason, it is important for the flexible films 11 and 12 not to hinder such communication between the resonance tags 30 and 40, and the transmission means and the reception means.

As such a resin described above, for example, a polyolefin resin, a polyamide resin, a polyester resin, a (meta) acryl resin, a vinyl chloride resin, a vinylidene chloride resin, a polyethersulphone, an ethylene vinyl alcohol copolymer, and the like are exemplified. Among these, the polyolefin resin is preferable in terms of excellent transparency, pliability, and hygiene, and a low cost.

As the polyolefin resin, for example, a polyolefin-based resin such as high-density polyethylene, medium-density polyethylene, high-pressure process low-density polyethylene, linear low-density polyethylene, an ethylene vinyl acetate copolymer, or the like; an olefin-based elastomer such as an ethylene-α-olefin random copolymer, or the like; a polypropylene-based resin such as polypropylene, an ethylene-propylene random copolymer, an α-olefin-propylene random copolymer, or the like; a cyclic polyolefin resin, and the like can be mentioned. A single-layered film and a multi-layered film of the mixture of the resins, and the like can be mentioned. Some of the resins may be crosslinked for the purpose of the improvement of heat resistance, or the like. As a film made of such a resin, one with the thickness of 50 to 1000 μm, and preferably about 100 to 500 μm is used.

Furthermore, when the barrier property against oxygen, water vapor, or the like is necessary, a material containing metal such as aluminum foil, aluminum foil-laminated film, or the like can be used. It is not a problem of using a film containing metal such as aluminum foil, aluminum foil-laminated film, or the like for the purpose of light-shielding, a barrier, or the like. However, such a film containing the metal above has a possibility of affecting communication of the resonance tags 30 and 40. For this reason, when a film containing such metal is adopted, the work of detaching the film containing the metal from the flexible films 11 and 12, or the like is performed before the use of the multi-chambered container for medical use 10. Therefore, it is necessary to use the films in a form that is not contrary to the object of the present invention.

For the base material 36 of the resonance tags 30 and 40, a dielectric material is used. For example, a resin film composed of a polyester resin such as polyimide, polyethylene terephthalate, polyethylene naphthalate, or the like and a polyolefin resin such as a polypropylene, polyethylene, or the like is preferably used. The thickness of the base material 36 is preferably 5 μm to 500 μm. The electrodes 32a and 32b, the antenna part 34, the lead wire part 37 are formed of metal such as aluminum, or the like. The forming method is not particularly limited, and a known method such as a method of etching aluminum foil laminated on the base material 36, a method by pattern printing, or the like can be mentioned.

Furthermore, for the resonance tags 30 and 40, those in the related art can be used in consideration of required functions, and the tags are not limited to those shown in FIGS. 3A and 3B. However, as shown in FIGS. 3A and 3B, when the resonance tags 30 and 40 in which the electrodes 32a and 32b forming a pair are arranged substantially at the center of the base material 36 and the spiral antenna part 34 is arranged in the vicinity thereof are heated, the base material 36 is difficult to shrink. For this reason, even when the multi-chambered container for medical use 10 to which the resonance tags 30 and 40 are attached and which contains drugs undergoes a retort sterilization process under a high temperature, deformation of the resonance tags 30 and 40 caused by shrinkage of the base material 36 is suppressed. For this reason, it is possible to prevent a problem such as deterioration of the appearance of the resonance tags 30 and 40, an adverse effect to communication, or the like.

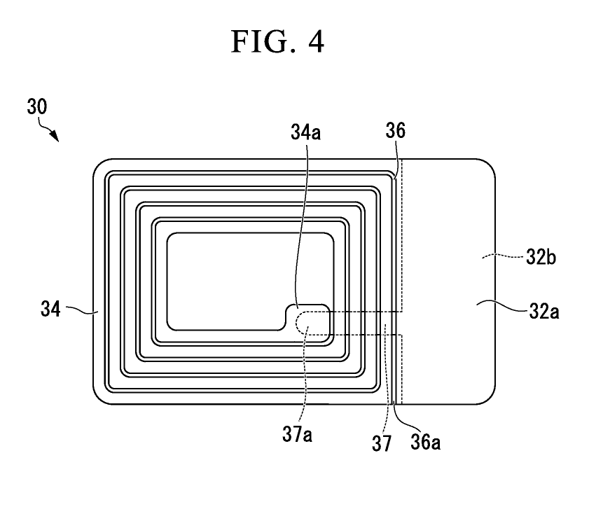

As a resonance tag, for example, there is also an embodiment, as shown in FIG. 4, in which a pair of electrodes 32a and 32b is arranged in one end part side, not the center, and the spiral antenna part 34 is arranged in the portion where the electrodes 32a and 32b are not arranged. Such a resonance tag may also be adopted, but the resonance tag includes a linear base material part 36a between the electrode 32a and the antenna part 34. For this reason, intense stress is easily exerted on the linear base material part 36a, and only the base material part 36a locally shrinks with ease. In such a case, there is a possibility that a problem such as deterioration of the appearance of the resonance tag, an adverse effect to communication, or the like may arise. On the other hand, the resonance tags 30 and 40 in the form shown in FIGS. 3A and 3B is a form in which the electrodes 32a and 32b are arranged substantially at the center, and the antenna part 34 is arranged in the vicinity thereof. Thus, the electrodes 32a and 32b and the antenna part 34 are evenly arranged all around. For this reason, even when the base material 36 shrinks due to heating, the degree of shrinkage becomes uniform all around, and local shrinkage that seems to occur in the resonance tag of FIG. 4 hardly arises.

The size and shape of the resonance tags 30 and 40 may be those that can be separated from each other according to an operation of the flexible films 11 and 12 when the weak seal part 26 is detached. As long as the resonance tags 30 and 40 as above are provided, it does not matter that the tags have different sizes and shapes or the same size and shape. In addition, as a resonant frequency of the resonance tags 30 and 40, a frequency may be possible at which the resonance tags 30 and 40 resonate by electromagnetic waves from the transmission means to emit echo waves, and the reception means can receive the echo waves. Specifically, 8.2 MHz, 9.5 MHz, 10.5 MHz, and the like can be exemplified, and it can be decided according to use aspects of the multi-chambered container for medical use 10. In addition, the resonance tags 30 and 40 may have the same resonant frequency or different resonance frequencies. However, in light of carrying out stable recognition of drug mixtures, it is preferable to use tags having the same resonant frequency.

The resonance tags 30 and 40 are provided so as to interpose the weak seal part 26. However, the resonance tags 30 and 40 may be arranged so as to be misaligned to an extent that opening or non-opening of the weak seal part 26 is discriminated. In addition, in this embodiment, in the resonance tags 30 and 40, the face on which the lead wire part 37 is formed is attached to the flexible film 11 by the adhesive 38, but the face on which the antenna part 34 is formed may be attached thereto.

The multi-chambered container for medical use 10 can be produced in the production method of, for example, the following (1) to (5). (1) The flexible films 11 and 12 are superimposed, and the circumference part in the side edge part 17 is fused by heat sealing. (2) A detachable seal is disposed at a position comparting the first drug storing chamber 22 and the second drug storing chamber 24 so as to provide the weak seal part 26. (3) The resonance tags 30 and 40 are arranged so as to interpose the weak seal part 26. (4) The faces on which the lead wire parts 37 of the resonance tags 30 and 40 are attached so as to come into contact with the flexible films 11 and 12 by the adhesive 38. (5) The outlet 14 is inserted between the flexible films 11 and 12 so that the outlet 14 is positioned at an arbitrary position in the lower end part 15, and the lower end part 15 is fused by heat-sealing. In this way, the multi-chambered container for medical use 10 can be obtained.

Furthermore, the multi-chambered container for medical use 10 described above can be filled with drugs in the production method of, for example, the following (1) to (3). (1) An arbitrary amount of a first drug A is made to fill the first drug storing chamber 22 from the upper end part 13 of the multi-chambered container for medical use 10. (2) The upper end part 13 is fused by heat-sealing, and an arbitrary position in the upper end part 13 that has undergone fusion is perforated so as to provide the hanging hole 16. (3) A second drug B is made to fill the second drug storing chamber 24 from, for example, the outlet 14, the outlet 14 is plugged by a rubber plug, or the like, and further the outlet 14 is covered by a detachable protective film. In this way, the multi-chambered container for medical use 10 can be obtained in which the first drug A fills the first drug storing chamber 22, and the second drug B fills the second drug storing chamber 24.

In addition, the drug-filled multi-chambered container for medical use 10 can be produced even in the production method of, for example, the following (1) to (7). (1) The flexible films 11 and 12 are superimposed, and the circumference part in the side edge part 17 is fused by heat sealing. (2) The outlet 14 is inserted between the flexible films 11 and 12 so that the outlet 14 is positioned at an arbitrary position in the lower end part 15, and the lower end part 15 is fused by heat-sealing. (3) A detachable seal is disposed at a position comparting the first drug storing chamber 22 and the second drug storing chamber 24 so as to provide the weak seal part 26. (4) An arbitrary amount of the first drug A is made to fill the first drug storing chamber 22 from the upper end part 13. (5) The upper end part 13 is fused by heat-sealing, and an arbitrary position in the upper end part 13 that has undergone fusion is perforated so as to provide the hanging hole 16. (6) A second drug B is made to fill the second drug storing chamber 24 from the outlet 14, the outlet 14 is plugged by a rubber plug, or the like, and further the outlet 14 is covered by a detachable protective film. (7) After that, the resonance tags 30 and 40 are provided on the flexible films 11 and 12 so as to interpose the weak seal part 26. In this way, a drug-filled multi-chambered container for medical use in which the multi-chambered container for medical use 10 stores the first and the second drugs A and B can be obtained.

As a formation method of the weak seal part 26, for example, a method can be applied in which the inner faces of the portions forming the weak seal part of the container main body 20 are heat-sealed using a film made of a resin and formed such that a layer, which is composed of a resin composition made of a mixture of polyethylene and polypropylene, or the like having different melting points and compatible properties, forms the inner face of the container main body 20. Alternatively, a method in which heat-sealing is performed at a low temperature to have weak adhesion in a semi-welded state, a method of using a flexible material obtained such that a formation portion of the weak seal part 26 is crosslinked by electron beams, or the like in advance, a method of using a seal bar that generates a strongly fusedportion at a specific area ratio, a method of putting a resin tape with an easy-detachable property between the flexible films 11 and 12, or the like can be mentioned.

The timing of adhesion of the resonance tags 30 and 40 is not particularly limited. For example, the resonance tags 30 and 40 may be provided before the weak seal part 26 is provided.

The first drug A may have fluidity, and a liquid, powdery drug or the like can be mentioned. The second drug B is the same as the first drug A. However, the multi-chambered container for medical use 10 is mostly used in storing drugs for transfusion or injection. For this reason, either of the first drug A or the second drug B is a liquid drug, or both of the first drug A and the second drug B are liquid drugs.

The filling amounts of the first drug A and the second drug B are decided according to the types of the drugs. The volume and the shape of the multi-chambered container for medical use 10 can be decided taking the range of separation of the resonance tags 30 and 40 when the weak seal part 26 is detached into consideration. The range of separation of the resonance tag 30 from the resonance tag 40 when the weak seal part 26 is detached may be set to be a distance in which mutual influence caused by proximity of each other is excluded, and the resonance tags 30 and 40 can resonate with a specific frequency emitted from the transmission means, and the distance can be decided according to the performance of the resonance tags 30 and 40. The separation distance is preferably, for example, 5 mm or longer.

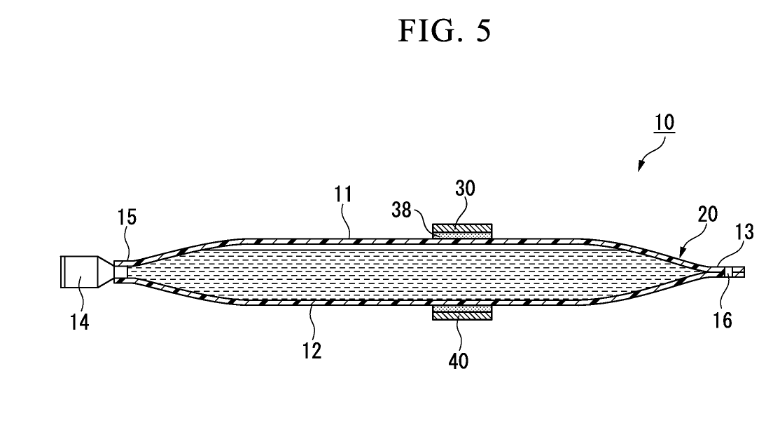

A recognition method of drug mixture used in the multi-chambered container for medical use 10 according to the present invention will be described below. First, the case where the resonance tags 30 and 40 have the same resonant frequency will be described using FIGS. 2 and 5. FIG. 5 is a cross-sectional view of the multi-chambered container for medical use 10 in a state where the weak seal part 26 is detached.

First, as shown in FIG. 2, the multi-chambered container for medical use 10 of which the weak seal part 26 is sealed is prepared. At this point, the container is in the state where the weak seal part 26 is sealed, in other words, in the state where the resonance tags 30 and 40 abut each other via the weak seal part 26. For this reason, even if the transmission means sends electromagnetic waves of the resonant frequency, the resonance tags 30 and 40 affect each other, the communication is prevented, and neither of the tags resonates. For this reason, the resonance tags 30 and 40 do not communicate with the reception means such as a checker, or the like without transmitting echo waves.

Next, if the first drug storing chamber 22 or the second drug storing chamber 24 of the multi-chambered container for medical use 10 shown in FIG. 2 is pressed from outside with arbitrary pressure, the weak seal part 26 is detached and the first drug storing chamber 22 communicates with the second drug storing chamber 24 as shown in FIG. 5. Then, the first drug A and the second drug B are mixed.

In addition, when the weak seal part 26 is detached in that way, the resonance tag 30 located on the flexible film 11 and the resonance tag 40 located on the flexible film 12 are set apart. If the resonance tags 30 and 40 are set apart from each other as such, mutual influence is excluded, and both of the resonance tags 30 and 40 resonate by electromagnetic waves from the transmission means, and transmit echo waves. Then, the reception means receives the echo waves. As a result, it can be recognized that the weak seal part 26 is detached and the first drug A and the second drug B are mixed.

As shown in the example, if the resonance tags 30 and 40 have the same resonant frequency, both of the resonance tag 30 located on the flexible film 11 and the resonance tag 40 located on the flexible film 12 perform communication with the transmission means and the reception means. For this reason, it is possible to achieve stable communication regardless of the positional relationship and orientation of the multi-chambered container for medical use 10 and the transmission means and the reception means, and to more stably identify drug mixture.

On the other hand, when the resonance tags 30 and 40 have different resonance frequencies from each other, it may be possible that the transmission means is made to send the resonant frequency of either resonance tag 30 or 40. In this case, when the weak seal part 26 is detached and the resonance tags 30 and 40 are set apart from each other, a resonance tag resonating by the resonant frequency sent from the transmission means resonates and sends echo waves. Then, with reception of the echo waves by the reception means, mixture of the first drug A and the second drug B can be identified.

However, when the resonance tags 30 and 40 have difference resonance frequencies from each other as above, either of the resonance tag 30 or 40 does not perform communication with the transmission means and the reception means. For this reason, it is preferable to set the communication stably performed by taking into consideration the positional relation and orientation of the multi-chambered container for medical use and the transmission means and the reception means, or the like, such as setting the multi-chambered container for medical use so that the face on which a resonance tag performing communication is provided is directed to the transmission means and the reception means.

Furthermore, the transmission means and the reception means may be individual devices, and may be the same device including the functions of both.

According to the multi-chambered container for medical use of the present invention, by enabling the resonance tags to perform communication with detachment of the weak seal part, it is possible to reliably and easily perform the work of mixing drugs without relying on only visual contact. In addition, since it is possible to identify as needed that drugs are mixed even after the detachment of the weak seal part, it is possible to reliably make sure accuracy in medical practice. Particularly, in the method of using such resonance tags, there is no possibility of mistakenly administering drugs not mixed even when the resonance tags are unexpectedly damaged before detachment of the weak seal part. In other words, when the resonance tags are damaged, the resonance tags do not resonate even after the weak seal part is detached, it is just falsely identified that the weak seal part remains not to be detached. Therefore, erroneous administration of not-mixed drugs will not occur. In addition, when the resonance tags 30 and 40 have the same resonant frequency, it is possible to identify drug mixture more stably, regardless of the positional relationship and the orientation of the multi-chambered container for medical use and the transmission means and the reception means. Furthermore, since the resonance tags have a simple structure and are relatively inexpensive in light of the disposable use, it is possible to provide the multi-chambered container for medical use at low cost.

Furthermore, the present invention is not limited to the above-described embodiment.

The multi-chambered container for medical use 10 described above has the container main body 20 partitioned into two drug storing chambers of the first drug storing chamber 22 and the second drug storing chamber 24. But, the multi-chambered container for medical use of the invention may be partitioned into three or more drug storing chambers.

The shape of the weak seal part 26 of the multi-chambered container for medical use 10 described above is described to be a straight line shape. But, the shape of the weak seal part may be a curved shape or an arc shape.

To the multi-chambered container for medical use 10 described above, the resonance tags 30 and 40 adhere by the adhesive 38. But, by setting the flexible film as a multi-layered film, for example, the resonance tags may be arranged between the layers constituting the multi-layered film.

In the multi-chambered container 10 for medical use described above, the container main body 20 is formed by bonding the flexible films 11 and 12 together. But, the container main body may be formed by, for example, blow molding.

### Example

Hereinafter, an example according to the present invention will be described in detail, but the invention is no limited to the example.

### Example

A multi-chambered container for medical use that is the same as the multi-chambered container for medical use 10 shown in FIG. 1 is produced with the following specifications and used. A first drug storing chamber of the produced multi-chambered container for medical use was filled with 1000 mL of water and a second drug storing chamber was filled with 1000 mL of water. Then, to a weak seal part of the water-filled multi-chambered container for medical use prepared as above, a resonance tag handy-type reader (BODY SCANNER, made by Gateway) equipped with a function as transmission means transmitting electromagnetic wave with the frequency of 8.2 MHz and a function as reception means receiving echo waves sent by resonance tags were brought closer. At this point, the resonance tag handy-type reader has not received anything. In this state, the weak seal part of the multi-chambered container for medical use was detached, the first drug storing chamber communicates with the second drug storing chamber. Then, the reception status of the echo waves by the resonance tag handy-type reader at that moment was checked. The same operation was performed for a total of three pouches of water-filled multi-chambered container for medical use, and the reception status was checked.

### Specifications of the Multi-Chambered Container for Medical Use

Flexible film material: Polyethylene

First drug storing chamber: Width of 29 cm×length of 16 cm

Second drug storing chamber: Width of 29 cm×length of 17 cm

Resonance tag: The same ones were used for a pair of resonance tags. In other words, resonance tags made by Miyake, Inc. with the model number of DS3040, having the resonant frequency of 8.2 MHz, and including a polypropylene-based material with the thickness of 20 μm were used.

As a result of checking the reception status for the total three pouches as described above, in the entire three pouches, the resonance tag handy-type reader did not receive echo waves before detachment of the weak seal part, but could receive the echo waves after detachment of the weak seal part. In addition, even after the positional relationship between the multi-chambered container for medical use and the resonance tag handy-type reader is varied, the echo waves can be stably received in the same manner.

Based on this point, it was clarified that, in the multi-chambered container for medical use, it is possible to confirm that the weak seal part had been detached based on the reception of the resonance tag handy-type reader, or the like, and the work of mixing drugs is reliably performed without relying on only visual contact.

### INDUSTRIAL APPLICABILITY

According to the present invention, it is possible to provide a multi-chambered container for medical use that enables an easy work of mixing drugs and drug mixture in an assured manner without relying on only visual contact at a low cost, a drug mixture identification method, and a drug-filled multi-chambered container for medical use using the same. Accordingly, it is possible to reliably and accurately confirm correctness of medical practice.

### REFERENCE SIGNS LIST

10 multi-chambered container for medical use
11, 12 flexible film
20 container main body
22 first drug storing chamber
24 second drug storing chamber
26 weak seal part
30, 40 resonance tag

1. A multi-chambered container for medical use comprising:
a container main body having flexibility;
a weak seal part that is detachable and seals opposing faces of the container main body;
drug storing chambers formed in such a way that the container main body is partitioned into two or more by the weak seal part; and
a pair of resonance tags that are provided in the container main body so as to interpose the weak seal part.

2. A drug mixture identification method using the multi-chambered container for medical use according to claim 1 storing two or more drugs, comprising the steps of:
setting the weak seal part to be in a state of performing sealing;
mixing two or more kinds of drugs by detaching the weak seal part and setting the pair of resonance tags to be apart from each other; and
allowing at least one of the pair of resonance tags to resonate by electromagnetic waves from transmission means so as to send echo waves and identifying detachment of the weak seal part after reception means receives the echo waves.

3. A drug-filled multi-chambered container for medical use, wherein the multi-chambered container for medical use according to claim 1 stores drugs.
